(19) United States
(12) Patent Application Publication
(10) Pub. No.: US 2026/0095084 A1
(43) Pub. Date: Apr. 2, 2026

(54) RESOLVER

(71) Applicant: SANYO DENKI CO., LTD., Tokyo (JP)

(72) Inventors: Daisuke YAMAGUCHI, Tokyo (JP); Kazuhiro MAKIUCHI, Tokyo (JP); Kenta MATSUHASHI, Tokyo (JP)

(21) Appl. No.: 19/337,276

(22) Filed: Sep. 23, 2025

(30) Foreign Application Priority Data
Sep. 27, 2024 (JP) 2024-168817

(51) Int. Cl. H02K 24/00

(52) U.S. Cl. CPC H02K 24/00

(57) ABSTRACT

Provided is a resolver including: a tooth; a stator core; and a coil, in which a plurality of the teeth is arranged in a circumferential direction of the stator core, and protrudes in a radial direction of the stator core, the coil is attached to each of the plurality of the teeth, and the coil attached to at least one of the plurality of the teeth is placed at a position different in the radial direction of the stator core from the coils attached to the other teeth.

### CROSS-REFERENCE TO RELATED APPLICATION

This application is based on Japanese Patent Application No. 2024-168817 filed with the Japan Patent Office on September 27, 2024, the entire content of which is hereby incorporated by reference.

### BACKGROUND

### TECHNICAL FIELD

The present disclosure relates to a resolver.

### RELATED ART

In a resolver disclosed in JP-A-2012-239310, an exciting winding is wound outward in a stator core radial direction from a distal end projection portion of a tooth of a stator core. In other words, the exciting winding is wound on the distal end projection portion side of the tooth, which reduces variations in the position of the exciting windings. Moreover, it is possible to detect a rotation angle with high accuracy.

### SUMMARY

A resolver according to the present embodiment includes: a tooth; a stator core; and a coil. In the resolver, a plurality of the teeth is arranged in a circumferential direction of the stator core, and protrudes in a radial direction of the stator core, the coil is attached to each of the plurality of the teeth, and the coil attached to at least one of the plurality of the teeth is placed at a position different in the radial direction of the stator core from the coils attached to the other teeth.

### BRIEF DESCRIPTION OF DRAWINGS

FIG. 1 is a top view of a resolver according to the embodiment;

FIG. 2 is a partial enlarged view of a stator used in the embodiment, illustrating the stator before output coils are mounted thereon;

FIG. 3 is a top view schematic of the output coil used in the embodiment; and

FIG. 4 is a partial enlarged view of the stator used in the embodiment, illustrating the stator after the output coils are mounted thereon.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In recent years, for example, a high-resolution resolver has been required which is used for a motor for an electric motor or a motor for a construction machine. Hence, increasing the number of teeth arranged in a circumferential direction of a stator core and increasing the number of output coils to be attached to the teeth are being studied to realize a high-resolution resolver. However, if the number of output coils increases, output coils adjacent in the circumferential direction may interfere with one another. It is necessary to increase spacing between the adjacent output coils with an increased diameter of the stator coil to prevent the interference between the adjacent output coils. Hence, there arises a problem that the size of the resolver increases in turn.

Hence, an object of the present disclosure is to provide a small, high-resolution resolver.

### Means for solving the problem

A resolver according to the present embodiment includes: a tooth; a stator core; and a coil. In the resolver, a plurality of the teeth is arranged in a circumferential direction of the stator core, and protrudes in a radial direction of the stator core, the coil is attached to each of the plurality of the teeth, and the coil attached to at least one of the plurality of the teeth is placed at a position different in the radial direction of the stator core from the coils attached to the other teeth.

According to the present disclosure, it is possible to provide a small, high-resolution resolver.

The embodiment is described hereinafter with reference to the drawings. Note that descriptions of members having the same reference numerals as those of members that have already been described are omitted in DETAILED DESCRIPTION for convenience of description. Moreover, the dimensions of each member illustrated in the drawings may be different from actual dimensions thereof for convenience of description.

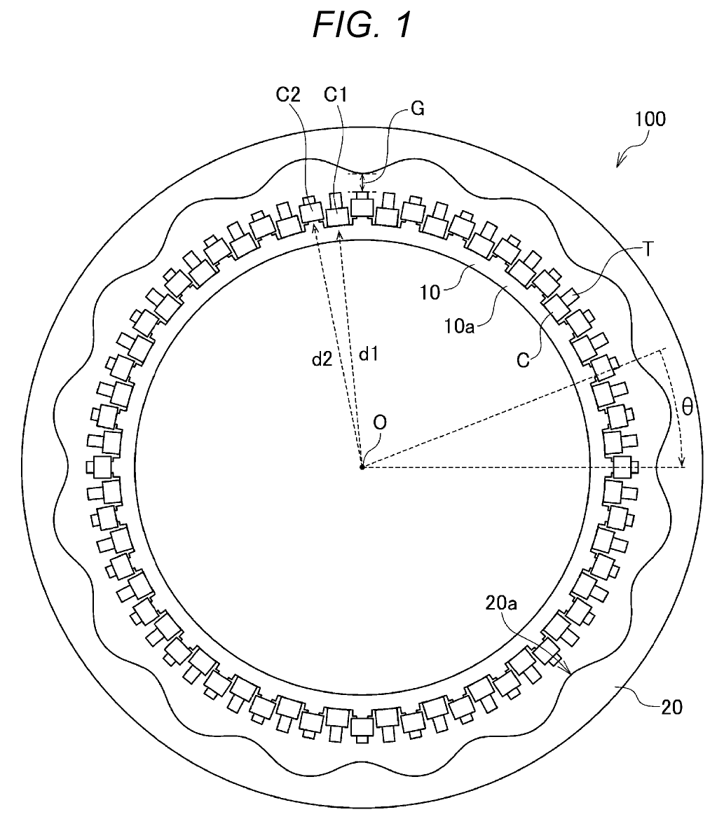

FIG. 1 is a top view of a resolver 100 according to the embodiment. The resolver 100 is of the outer rotor type. The resolver 100 includes an approximately ring-shaped stator 10, and an approximately ring-shaped rotor 20. The rotor 20 is provided on an outer peripheral side of the stator 10 in such a manner as to be rotatable. The resolver 100 detects the rotational quantity of the rotor 20 relative to the stator 10. The resolver 100 is, for example, a sensor that detects the rotational quantity of a body of rotation such as a motor. A description is given below, assuming that the resolver 100 is a sensor that detects the rotational quantity of a motor relative to a housing, for description.

The stator 10 includes an approximately ring-shaped stator core 10a, and approximately rectangular parallelepiped-shaped teeth T. The teeth T protrude outward in a radial direction of the stator core 10a (a stator core 10a′s radial direction) from the stator core 10a. Furthermore, the teeth T are spaced equally in a circumferential direction of the stator core 10a (a stator core 10a′s circumferential direction). In the illustration of FIG. 1, a resolver coil C is attached to each of all the teeth T. The teeth T are configured in such a manner that a distance from a rotation center O of the resolver 100 to a distal end portion of the each of the teeth T is equal.

The rotor 20 is a member that is rotatable relative to the stator 10. In the illustration of FIG. 1, the rotor 20 is provided on the outer peripheral side of the stator 10. The rotor 20 is fixed to, for example, a member such as a motor shaft that is rotated by a motor targeted for detection, or a gear attached to the motor shaft. The rotor 20 is an approximately ring-shaped member. An outer peripheral surface of the rotor 20 may have a circular shape in front view.

An inner peripheral surface of the rotor 20 is successively provided with projections and depressions 20a in its circumferential direction. The presence of the projections and depressions 20a changes a thickness of the rotor 20 cyclically in its radial direction (a dimension from the inner peripheral surface to the outer peripheral surface). In the illustration of FIG. 1, the thickness of the rotor 20 in the radial direction varies cyclically along the circumferential direction. In other words, a gap G from the inner peripheral surface of the rotor 20 to the distal end portion of each of the teeth T of the stator 10 changes in the circumferential direction. Hence, when the rotor 20 rotates relative to the stator 10, gap permeance between the rotor 20 and the stator 10 changes in a sine wave form according to a rotation angle θ of the rotor 20.

As illustrated in FIG. 3, the resolver coil C includes an exciting coil Cin and an output coil Cout. An alternating current power supply (not illustrated) is connected to the exciting coil Cin. When alternating current flows through the exciting coil Cin, magnetic flux M is generated on the tooth T to which the resolver coil C is attached. The magnetic flux M interlinks with the output coil Cout.

The flux linkage generates an electromotive force (a resolver signal) on the output coil Cout in accordance with the rotation angle θ of the rotor 20. An RD converter (not illustrated) is connected to the output coil Cout. The RD converter detects the rotation angle of the motor on the basis of the resolver signal.

In the illustration of FIG. 1, the inner peripheral surface of the rotor 20 is provided with 16 pairs of the projections and depressions 20a. Hence, its multiplication factor of angle is 16X. When the rotor 20 completes one full revolution, a 16-cycle output signal of the motor is acquired. Note that in the embodiment, the multiplication factor of angle is not limited to 16X.

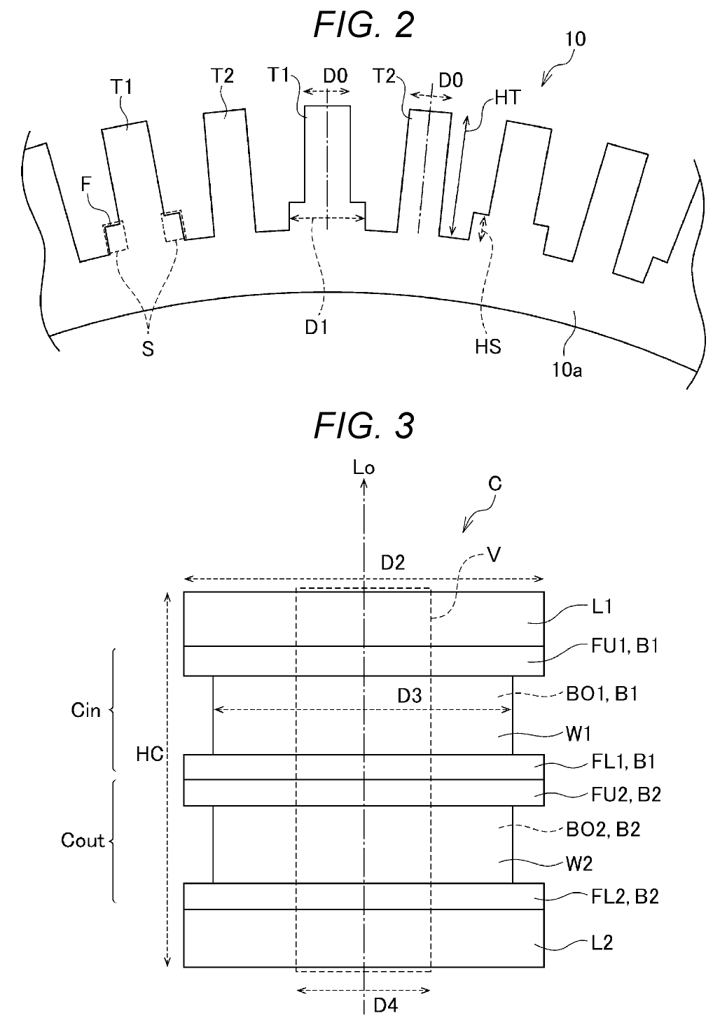

FIG. 2 is a partial enlarged view of the stator 10 used in the embodiment, illustrating the stator 10 before the resolver coils C are mounted thereon. As illustrated in FIG. 2, the stator 10 is provided with first teeth T1 and second teeth T2. The first teeth T1 are different in shape from the second teeth T2. Each of the first teeth T1 is provided with a step portion S. The second teeth T2 are provided with no step portion. The first teeth T1 and the second teeth T2 are alternately provided in the stator core 10a′s circumferential direction. Note that the height of the first teeth T1 in the stator core 10a′s radial direction is substantially equal to the height of the second teeth T2 in the radial direction. In the following description, the first teeth T1 and the second teeth T2 may not be particularly distinguished, and may be simply referred to as the teeth T.

The step portions S are parts for positioning the resolver coils C in the stator core 10a′s radial direction. In the illustration of FIG. 2, the step portions S are provided at proximal end portions of the first teeth T1, respectively. The step portions S are rectangular parts that are wider than the first teeth T1. A top surface F (an outer surface in the stator core 10a′s radial direction) of each of the step portions S suppresses movement of its respective resolver coil C inward of the top surface F in the stator core 10a′s radial direction. As a result, the step portions S aid in positioning the resolver coils C in the radial direction. The first teeth T1 and the second teeth T2 are alternately provided in the stator core 10a′s circumferential direction. Hence, as illustrated in FIG. 1, a distance d1 from the rotation center O of the resolver 100 to each of resolver coils C1 is different from a distance d2 from the rotation center O to a resolver coil C2 adjacent to the resolver coil C1 in the stator core 10a′s circumferential direction.

Note that in the illustration of FIG. 2, the example where the step portions S being the rectangular parts are formed is described. However, the shape of the step portions S is not limited to this example.

FIG. 3 is a top view schematic of the resolver coil C used in the embodiment. The resolver coil C includes the exciting coil Cin, the output coil Cout, and a pair of an approximately rectangular parallelepiped-shaped first lid portion L1 and second lid portion L2.

The exciting coil Cin includes a coil bobbin B1 and a winding W1. The coil bobbin B1 includes an approximately rectangular parallelepiped-shaped core portion BO1 and a pair of an approximately rectangular parallelepiped-shaped first flange FU1 and second flange FL1. The coil bobbin B1 extends in a central axis direction Lo of the resolver coil C. The pair of the first flange FU1 and the second flange FL1 is provided in such a manner as to sandwich the core portion BO1 in the central axis direction Lo. The winding W1 is wound around the core portion BO1 of the coil bobbin B1. The output coil Cout has a similar configuration to that of the exciting coil Cin. Hence, a description of the output coil Cout is omitted.

The exciting coil Cin and the output coil Cout are sandwiched in the central axis direction Lo by the pair of the first lid portion L1 and the second lid portion L2. The exciting coil Cin, the output coil Cout, and the pair of the first lid portion L1 and the second lid portion L2 are provided with an internal space V. The tooth T is inserted through the internal space V. Note that in FIG. 1, after each of the resolver coils C is attached to its respective tooth T, the first lid portion L1 is located on one of the outer or inner side in the stator core 10a′s radial direction. At this point in time, the second lid portion L2 is located on the other of the outer or inner side in the radial direction.

Here, the length, in a lateral direction of the page of FIG. 3, of the first lid portion L1, the second lid portion L2, the first flange FU1 and the second flange FL1 of the coil bobbin B1, and a first flange FU2 and a second flange FL2 of a coil bobbin B2 is denoted by D2 (hereinafter also referred to as the resolver coil width D2). Moreover, the length, in the lateral direction of the page of FIG. 3, of the winding W1 wound around the core portion BO1 of the coil bobbin B1 and a winding W2 wound around a core portion BO2 of the coil bobbin B2 is denoted by D3 (hereinafter also referred to as the winding width D3). Moreover, the length of the internal space V in the lateral direction of the page of FIG. 3 is denoted by D4 (hereinafter also referred to as the internal space width D4).

Moreover, as illustrated in FIG. 2, the length of the distal end portion of the tooth T in the stator core 10a′s circumferential direction is denoted by D0 (hereinafter also referred to as the tooth width D0). Moreover, the length of the step portion S in the circumferential direction is denoted by D1 (hereinafter also referred to as the step portion width D1).

The winding W1 wound around the core portion BO1 of the exciting coil Cin is accommodated between the first flange FU1 and the second flange FL1 of the coil bobbin B1. Hence, the output coil width D2 is greater than the winding width D3 (D2 > D3). Moreover, the winding width D3 is greater than the internal space width D4 (D3 > D4). Similar dimensional relationships also hold for the output coil Cout.

Moreover, the internal space width D4 is set to be greater than the tooth width D0 illustrated in FIG. 2 and less than the step portion width D1 (D1 > D4 > D0). In other words, the internal space width D4 is greater than the width D0 of the tooth T. Hence, the resolver coil C can be attached to the tooth T. Moreover, the internal space width D4 is less than the step portion width D1. Hence, the resolver coil C comes into contact with the top surface F of the step portion S of the first tooth T1 to be positioned in the radial direction.

Moreover, the height of the second tooth T2 in the stator core 10a′s radial direction, which is illustrated in FIG. 2, is denoted by HT. Moreover, the height of the step portion S in the stator core 10a′s radial direction is denoted by HS. In addition, a difference HT - HS in the height in the radial direction between the two is set in such a manner as to be greater than a height HC of the resolver coil C illustrated in FIG. 3 (HT - HS > HC). Consequently, the resolver coil C can be attached to the first tooth T1 without protruding outward in the radial direction from the distal end portion of the first tooth T1.

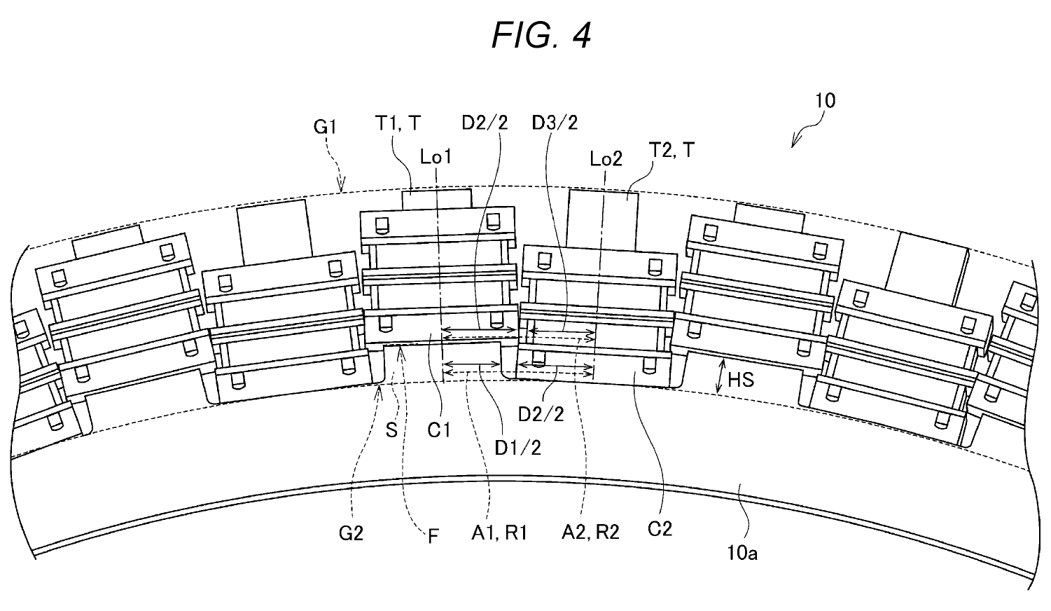

FIG. 4 is a partial enlarged view of the stator 10 used in the embodiment, illustrating the stator 10 after the resolver coils C are mounted thereon. As illustrated in FIG. 4, the resolver coils C1 are attached to the first teeth T1. Similarly, the resolver coils C2 are attached to the second teeth T2. Moreover, the resolver coils C1 are positioned in the stator core 10a′s radial direction in such a manner as to be in contact with the top surfaces F of the step portions S of the first teeth T1. Note that the resolver coils C1 and C2 have the same structure. Moreover, the winding specifications of the resolver coils C1 and C2 are also substantially the same. Specifically, the resolver coils C1 and C2 are substantially the same in dimension, shape, number of turns in a winding, resistance value, and inductance. As a result, the resolver coils C1 and C2 can share a coil bobbin. Consequently, the cost of components of the resolver coils C can be reduced.

In FIG. 4, an outer peripheral surface including distal end surfaces of the teeth T is denoted by G1. A boundary surface between the stator core 10a and the teeth T is denoted by G2. Moreover, a region from a central axis Lo1 of the first tooth T1 to a central axis Lo2 of the second tooth T2 on the boundary surface G2 is denoted by A1. The arc length of the region A1 is denoted by R1. Moreover, a region from the central axis Lo1 of the first tooth T1 to the central axis Lo2 of the second tooth T2 on a circumferential surface including the top surface F of the step portion S is denoted by A2. The arc length of the region A2 is denoted by R2.

Here, assume that the first teeth T1 do not include the step portions S, respectively, in contrast to the embodiment. Then the resolver coils C1 are attached in such a manner as to be in contact with the boundary surface G2 of the stator core 10a as in the resolver coils C2.

In this case, in FIG. 4, a right half of the resolver coil C1 and a left half of the resolver coil C2 are located in the region A1. A sum of a length D2/2 being half the width D2 of the resolver coil C1 and a length D2/2 being half the width D2 of the resolver coil C2 is D2. Hence, if the sum D2 is equal to or greater than the arc length R1 of the region A1, the resolver coil C1 and the resolver coil C2 interfere with each other at a midpoint between the first tooth T1 and the second tooth T2 on the boundary surface G2. Therefore, in order to prevent the interference between the resolver coils C1 and C2, it is necessary to make the arc length R1 of the region A1 greater than the sum D2 by increasing the diameter of the stator core 10a, which leads to an increase in the size of the resolver.

Hence, in the embodiment, as illustrated in FIG. 4, the step portions S having the width D1 less than the width D2 of the resolver coils C1 are provided to the first teeth T1, respectively. Consequently, the positions of the resolver coils C adjacent in the radial direction are different from each other, which is described in detail below.

As illustrated in FIG. 4, the region A1 includes a right half of the step portion S and the left half of the resolver coil C2. A sum of a length D1/2 of the right half of the width D1 of the step portion S and the length D2/2 of the left half of the width D2 of the resolver coil C2 is D2/2 + D1/2. The width D1 of the step portion S is set in such a manner that the sum D2/2 + D1/2 is less than the arc length R1 (D2/2 + D1/2 < R1). Moreover, the width D1 of the step portion S is set in such a manner as to be less than the width D2 of the resolver coil C1 (D1 < D2). Such dimensional relationships prevent the resolver coil C1 and the resolver coil C2 from interfering with each other in a region from the boundary surface G2 of the stator core 10a to the top surface F of the step portion S in the stator core 10a′s radial direction.

Moreover, the region A2 is located outward of the region A1 in the stator core 10a′s radial direction. Hence, the arc length R2 is greater than the arc length R1. In other words, it is possible to increase the arc length R2 by increasing the height HS of the step portion S in the radial direction. The region A2 includes the right half of the resolver coil C1 and the left half of the resolver coil C2. The sum of the length D2/2 being half the width D2 of the resolver coil C1 and the length D2/2 being half the width D2 of the resolver coil C2 is D2. The height HS of the step portion S is set in such a manner that the sum D2 is less than R2 (D2 < R2). Consequently, the resolver C1 and the resolver C2 do not interfere with each other in a region outward of the top surface F of the step portion S in the radial direction.

Note that in the illustration of FIG. 4, the region A2 includes the right half of the resolver coil C1 and a left half of the winding W2 of the resolver coil C2. A sum of the length D2/2 being half the width D2 of the resolver coil C1 and a length D3/2 of the left half of the width D3 of the winding W2 of the resolver coil C2 is D2/2 + D3/2. The height HS of the step portion S may be set in such a manner that the sum D2/2 + D3/2 is less than R2 (D2/2 + D3/2 < R2).

As in the above configuration, the width D1 and the height HS of the step portion S provided to the first tooth T1 are adjusted to enable suppressing the interference between the adjacent resolver coils C without increasing the diameter of the stator core 10a.

Note that in the embodiment, two adjacent resolver coils C are placed at different positions in the stator core 10a′s radial direction. However, the heights HT of two teeth T, to which these resolver coils C are attached, in the radial direction are the same. Hence, an influence on the detection accuracy of the resolver 100 is sufficiently small as compared to a case where the positions of the adjacent resolver coils C in the radial direction are the same.

As described above, in the configuration of the resolver according to the embodiment, the presence of the step portions S provided to the teeth T of the stator 10 causes the resolver coil C attached to one of the adjacent teeth T to be placed at a position different from the resolver coil C attached to the other tooth T, in the stator core 10a′s radial direction, which suppresses the interference between the adjacent resolver coils C. Consequently, it is possible to reduce the size of the high-resolution resolver 100.

Up to this point the resolver according to the embodiment has been described. However, it is needless to say that the technical scope of the embodiment should not be construed in a limited manner by the embodiment that has been described. The described embodiment is a mere example of the embodiment. Those skilled in the art understand that various embodiment modifications can be made to the described embodiment within the scope of the disclosure of the claims. The technical scope of the embodiment should be determined on the basis of the scope of the disclosure of the claims and the scope of equivalents thereof.

For example, in the example of the above-mentioned embodiment, the resolver is configured in such a manner that the positions of the resolver coils C in the stator core 10a′s radial direction are alternately changed. However, the resolver according to the embodiment is not limited to this example. One first tooth T1 may be placed first and then two second teeth T2 in the stator core 10a′s circumferential direction. In this case, the position of every third resolver C in the radial direction shifts outward in the stator core 10a′s radial direction. In this manner, the resolver may be configured in such a manner that the positions of the resolver coils C in the stator core 10a′s radial direction are cyclically changed. Moreover, the resolver may be configured in such a manner that the positions of the resolver coils C in the stator core 10a′s radial direction are randomly changed. Moreover, the resolver may be configured in such a manner that the position of at least one resolver coil C in the stator core 10a′s radial direction is different from the positions of the other resolver coils in the stator core 10a′s radial direction. Such configurations also enable a reduction in the size of the resolver 100 as compared to a case where the positions of all the resolver coils C in the stator core 10a′s radial direction are the same.

Moreover, in the resolver coil C illustrated in FIG. 3 in the embodiment, the winding W1 is wound around the coil bobbin B1, and W2 around the coil bobbin B2. However, the winding W1 and the winding W2 may be directly wound around the tooth T. Moreover, if the resolver coil C includes the windings W1 and W2 directly wound around the tooth T, the tooth T illustrated in FIG. 2 may have an approximately T shape in such a manner that the distal end portion located on the outer side in the stator core 10a′s radial direction is wider in the circumferential direction.

Moreover, in the embodiment, the positions of two adjacent resolver coils C in the stator core 10a′s radial direction are different from each other. The RD converter may correct the output signal from the resolver coils C on the basis of the difference to further reduce the influence of the difference on the detection accuracy of the resolver.

Moreover, the RD converter that is connected to the resolver 100 according to the embodiment may perform signal processing on the output signal by the amplitude modulation method or phase modulation method.

Moreover, the resolver 100 according to the embodiment that has been described above is of the outer rotor type. However, the resolver 100 according to the embodiment may be of the inner rotor type.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A resolver comprising:
a tooth;
a stator core; and
a coil, wherein
a plurality of the teeth is arranged in a circumferential direction of the stator core, and protrudes in a radial direction of the stator core,
the coil is attached to each of the plurality of the teeth, and
the coil attached to at least one of the plurality of the teeth is placed at a position different in the radial direction of the stator core from the coils attached to the other teeth.

2. The resolver according to claim 1, wherein
the plurality of the teeth includes first teeth each having a step portion, and second teeth having no step portion, and
each of the step portions is configured to position the coil in the radial direction of the stator core.

3. The resolver according to claim 2, wherein the first teeth and the second teeth are alternately placed in the circumferential direction of the stator core.

4. The resolver according to claim 1, wherein winding specifications of the coil attached to one of the plurality of the teeth are substantially the same as winding specifications of all the coils attached to the remaining teeth.

5. The resolver according to claim 1, wherein the resolver is of an outer rotor type.
